(19) United States
(12) Patent Application Publication
(10) Pub. No.: US 2022/0010616 A1
(43) Pub. Date: Jan. 13, 2022

(54) TURNOVER DEVICE AND SLOTLESS ROLLING DOOR COMPRISING THE SAME

(71) Applicant: Jianzhi LI, Guangzhou (CN)

(72) Inventor: Jianzhi LI, Guangzhou (CN)

(21) Appl. No.: 17/289,939

(22) PCT Filed: Dec. 19, 2018
(86) PCT No.: PCT/CN2018/122023

§ 371 Date: Apr. 29, 2021

(30) Foreign Application Priority Data
Oct. 31, 2018 (CN) 201811288546.6

(51) Int. Cl. E06B 9/15

(52) U.S. Cl. CPC E06B 9/15; E06B 2009/1566

(57) ABSTRACT

A turnover device comprises a first turnover piece, a second turnover piece, a first pull rod and a second pull rod. The turnover device is immobilized upon impactor pull from the bottom. When a plurality of the first and the second turnover pieces are connected alternately, the second and the first turnover pieces are turned over one after another. A slotless rolling shutter door comprises two turnover devices which are arranged on two sides of the door body and can replace existing door slots formed in a wall body. The door body, with an improved appearance, is fixed without arranging the door slots in the wall body. When opening the door body, a door body winding device winds the turnover devices with door pieces to finally collect the door body and the turnover devices therein.

### TECHNICAL FIELD

The present invention relates to a turnover device and a slotless rolling shutter door comprising the same.

### BACKGROUND

Rolling shutter doors used in public places such as commercial facades, garages, shopping malls, hospitals, factories and mining enterprises need fixed slides on both sides, that is, concave door slots need to be installed on the wall to ensure the normal use of rolling shutter doors. However, providing door slots on the wall not only increases the installation costs of the rolling shutter door, but also makes the facade unsightly. Meanwhile, after a long time of use, a lot of dirt or dust will accumulate inside the door slots, which will breed bacteria and will be difficult to clean.

The impact resistance of the existing rolling shutter door is achieved by fixing the two sides of the rolling shutter door in the door slots. However, the wider the rolling shutter door, the greater the shaking of the door body, and the less impact resistance the rolling shutter door can withstand, which brings serious potential safety hazard.

### SUMMARY

An object of the present invention is to provide a turnover device and a slotless rolling shutter door comprising the same, so as to solve at least one of the above technical problems.

One aspect of the present invention provides a turnover device, including a first turnover piece, a second turnover piece, a first pull rod and a second pull rod, wherein both the first turnover piece and the second turnover piece have U-shaped cross section, one end of the first turnover piece is inserted into one end of the second turnover piece, the first turnover piece is hinged with the second turnover piece by means of shaft A, and when the first turnover piece is in line with the second turnover piece, the lower edge of one end of the first turnover piece and the lower edge of one end of the second turnover piece abut against each other, wherein the first pull rod is located in the first turnover piece, one end of the first pull rod is provided with a first hinge, being rotatable around the shaft A within a obround rotation hole, the first hinge is rotatably connected with the first pull rod, the second pull rod is located in the second turnover piece, and when the first turnover piece is in line with the second turnover piece, one end of the first pull rod and one end of the second pull rod abut against each other.

In the present invention, when the first turnover piece is in line with the second turnover piece, the first turnover piece and the second turnover piece cannot turnover when the bottom of the first turnover piece, the bottom of the second turnover piece, or the joint position of the bottoms of the first turnover piece and the second turnover piece is vertically pushed, since the lower edge of one end of the first turnover piece and the lower edge of one end of the second turnover piece abut against each other, that is to say that the turnover device is steady when impacted by the external force at the bottom. Meanwhile, when the first turnover piece is in line with the second turnover piece, the first turnover piece and the second turnover piece cannot turnover when the top of the first turnover piece, the top of the second turnover piece, or the joint position of the tops of the first turnover piece and the second turnover piece is vertically pushed, since one end of the first pull rod abuts against one end of the second pull rod, that is to say, the turnover device is also steady when impacted by external force at its top. In view of the above, the turnover device is steady whether it suffers from the impact at the bottom or the pulling force at the bottom. When the first turnover piece and the second turnover piece need to be rotated, the second pull rod can be pulled to make one end of the second pull rod separate from one end of the first pull rod, by this time, the second turnover piece can rotate around the shaft A to realize the rotation of the second turnover piece relative to the first turnover piece. While the second turnover piece rotates, the first hinge also rotates around the shaft A, which makes the first pull rod move towards the second pull rod. When another second turnover piece is also provided on the other end of the first turnover piece, the movement of the first pull rod will render the other end of the first pull rod being separated from the second pull rod of the another second turnover piece, thus, the rotation of the first turnover piece relative to the another second turnover piece can be realized. Similarly, when a plurality of first turnover pieces and a plurality of second turnover pieces are alternately connected, the second turnover pieces and the first turnover pieces can be turned over one by one, to finally realize the turnover and collecting of the whole part. The turnover device can be used on the rolling shutter doors, wherein two sets of turnover devices are installed on both sides of the door body. The door body is steady whether it suffers from external impact or pulling force. Therefore, the turnover devices on both sides of the rolling shutter door can replace the existing door slots provided on the walls to fix the door body, which renders the installation costs of the rolling shutter doors reduced (that is, no need to install the door slots on the walls), and the overall aesthetics of the rolling shutter doors improved. Additionally, the turnover device of the present invention can also be extendedly used as various forms of tools, such as ladders, work platforms, bridges or lap beams for breaking bridges or roads, etc. The turnover device of the present invention can also be used for conveyor belts as long as transfer plates parallel configured are installed between the two sets of turnover devices.

In some embodiments, one end of the first pull rod may be provided with a first protrusion, and the second pull rod may be provided with a first recess that cooperates with the first protrusion. Thus, when the first turnover piece is in line with the second turnover piece, one end of the first pull rod and one end of the second pull rod abut against each other, by this time, the first protrusion on the first pull rod is inserted into the first recess on the second pull rod to ensure that the first pull rod and the second pull rod abut firmly against each other. When the top of the first turnover piece, the top of the second turnover piece, or the joint position of the tops of the first turnover piece and the second turnover piece is vertically pushed, the first turnover piece and the second turnover piece cannot be turned over at all, ensuring that the turnover device is immobilized when the top of thereof is impacted externally. The insert cooperation between the first protrusion and the first recess further improves the stability of the top when it is impacted while the top of the first turnover piece is in line with the second turnover piece.

In some embodiments, the device may further comprise a first limit shaft, both ends of which are provided on two side walls of the first turnover piece respectively, the first pull rod is located below the first limit shaft, and the upper end surface of the first pull rod is in contact with the first limit shaft. Thus the first limit shaft can prevent the first pull rod from being tilted during the movement, ensuring the stability of the first and second turnover pieces when they are in line or during turnover process.

In some embodiments, the device may further comprise a shaft B, two ends of which are provided on two side walls of the second turnover piece respectively, the shaft B is inserted in the first hinge, and the first hinge can rotate around the shaft B. Therefore, when the second turnover piece rotates, the second turnover piece can drive the first hinge to rotate around the shaft A by means of the shaft B, which finally realizes that the rotation of the first hinge drives the first pull rod to move towards the second pull rod.

In some embodiments, the device may further comprise a second limit shaft and a shaft C, two ends of the shaft C are provided on the two side walls of the other end of the second turnover piece respectively, the other end of the second pull rod is provided with a second hinge, which is rotatably connected with the second pull rod, the second hinge is rotatable around the shaft C, the two ends of the second limit shaft are provided on the two side walls of the second turnover piece respectively, the second pull rod is located below the second limit shaft, and the upper end surface of the second pull rod is in contact with the second limit shaft. As a result, the second limit shaft can prevent the second pull rod from tilting during movement, thereby ensuring the stability of the first and second turnover pieces in line or during turnover process. The other end of the second turnover piece can be provided with another first turnover piece and another first pull rod by means of shaft C and the second hinge, and the structure and connection relationship of the another first turnover piece and the second pull rod are the same as the foregoing structure, so that the length of the turnover device is extended. Besides, the length of the turnover device can be extended as necessary with the first turnover piece and the second turnover piece being arranged alternately.

In some embodiments, the other end of the first pull rod may be provided with a second recess, and the other end of the second pull rod may be provided with a second protrusion. Therefore, when the plurality of first and second turnover pieces are arranged alternately and the plurality of first and second turnover pieces are in line, the first protrusion at one end of the first pull rod is inserted into the first recess at one end of the second pull rod, the second protrusion at the other end of the second pull rod is inserted into the second recess on the other end of the adjacent first pull rod (the subsequent first pull rod), and the second recess at the other end of the first pull rod can accommodate the second protrusion at the other end of the adjacent second pull rod (the preceding second pull rod), so that the first pull rod and the second pull rod arranged alternately abut against together one after another by means of the insert connection cooperation of the first protrusion and the first recess and the insert connection cooperation of the second protrusion and the second recess. Accordingly, when all the first and second turnover pieces are in line with one another, the stability of the whole turnover device is ensured in case an impact force is applied at the top of thereof.

In some embodiments, a lateral first connecting plate may be provided on the side wall of the first turnover piece, and a lateral second connecting plate may be provided on the side wall of the second turnover piece. Therefore, when the turnover device is installed on both sides of the rolling shutter door, the first connecting plate can fix door pieces of the door body (such as by screws, rivets, etc.), and the second connecting plate can also fix the door pieces of the door body (such as by screws, rivets, etc.). The installation of the door pieces to the turnover device is very convenient and fast.

In some embodiments, the number N of the first turnover pieces may be a natural number greater than or equal to 1, and the number M of the second turnover pieces may be a natural number greater than or equal to 2. The first turnover pieces and the second turnover pieces are connected alternately, wherein one end of a first turnover piece is hinged with one end of a second turnover piece by shaft A, the other end of the first turnover piece is hinged with one end of another second turnover piece by shaft C, and one end of the first turnover piece is inserted into one end of the second turnover piece, and the other end of the first turnover piece is inserted into one end of the another second turnover piece. As a result, a plurality of first turnover pieces and second turnover pieces are connected alternately, in which every first turnover piece connects to a second turnover piece in the same way, so that the length of the turnover device can be extended indefinitely as needed.

Another aspect of the present invention also provides a slotless rolling shutter door, which comprises at least two sets of the above-mentioned turnover devices, a door body and a door body winding device, wherein the door body comprises at least two door pieces which are located between the two sets of turnover devices, one end of the first door piece is provided on a side wall of a first turnover piece and the other end is provided on a side wall of another first turnover piece, one end of the second door piece is provided on aside wall of a second turnover piece and the other end is provided on aside wall of another second turnover piece, two adjacent door pieces are arranged in parallel, and the door body winding device is provided on the top of the door body.

In this way, the door body of the slotless rolling shutter door is steady whether it suffers from external impact or pulling force, thus, the turnover devices on both sides of the door body can fix the door body without the existing door slots provided on the wall, which not only reduces the installation costs of the rolling shutter door (that is, no need to install door slots on the wall), but can also improves the overall aesthetics of the door body. Meanwhile, when a very wide door body is need, multiple sets of turnover devices arranged in parallel can be installed, or multiple slotless rolling shutter doors can be connected together side by side to prevent the door from shaking resulting from the excessive width of the door body. When opening the door, the door winding device can wind the turnover device with the door pieces from top to bottom and finally both the door body and the turnover device can be collected into the door body winding device. In addition, when the door pieces are made of bullet-proof steel plate, bullet-proof and explosion-proof function can be realized, and thus security is greatly guaranteed. Moreover, when the door body is placed laterally, the door pieces can be rolled up and down, and when the door is placed longitudinally, the door pieces can roll left and right.

In some embodiments, the bottom of the door body may be provided with a lock body. Therefore, when the door body is in closed state, the existence of the lock body can ensure that the door body will not be rolled up by other person, so as to achieve the purpose of anti-theft.

### BRIEF DESCRIPTION OF THE DRAWINGS

FIG. 1 is a schematic structural diagram of a turnover device according to an embodiment of the present invention;

FIG. 2 is a schematic structural diagram of the turnover device shown in FIG. 1 along A direction;

FIG. 3 is a stereogram of the turnover device shown in FIG. 2, where in a second hinge, a shaft C, and a second limit shaft are omitted;

FIG. 4 is a schematic structural diagram of the first turnover piece in the turnover device shown in FIG. 3;

FIG. 5 is a schematic structural diagram of the first pull rod and the first hinge in the turnover device shown in FIG. 3;

FIG. 6 is a schematic structural diagram of a slotless rolling shutter door according to an embodiment of the present invention;

FIG. 7 is a schematic structural diagram of a slotless rolling shutter door according to another embodiment of the present invention.

### DETAILED DESCRIPTION

The present invention will be described in further detail below in conjunction with the accompanying drawings.

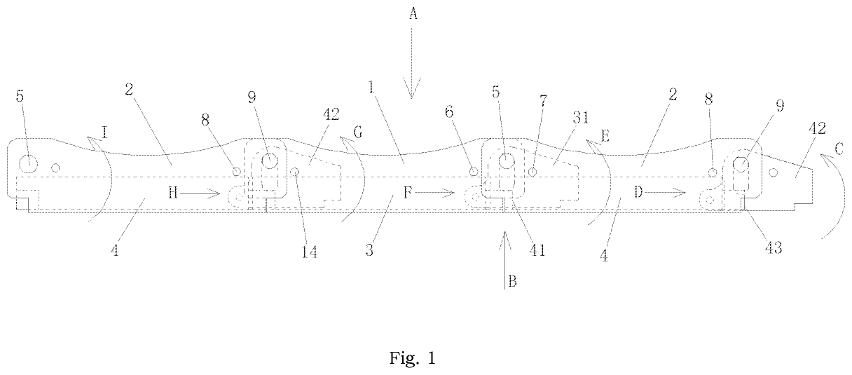

FIGS. 1 to 5 schematically show the structure of a turnover device according to an embodiment of the present invention.

As shown in FIGS. 1 to 5, the turnover device comprises a first turnover piece 1, a second turnover piece 2, a first pull rod 3, a second pull rod 4 and a shaft A5. In addition, the turnover device may further comprise a first limit shaft 6, a shaft B7, a second limit shaft 8, and a shaft C9.

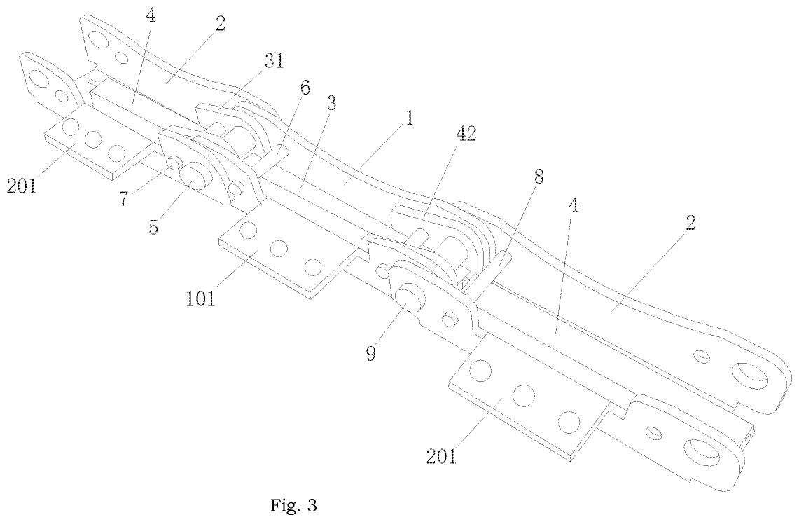

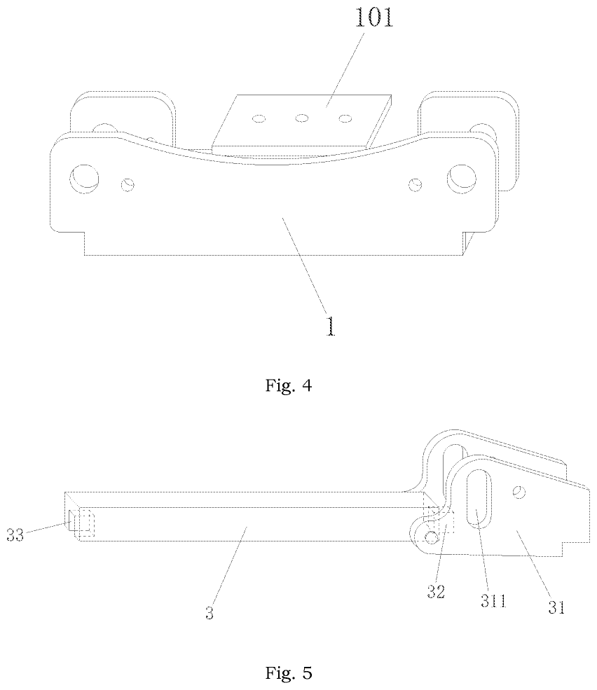

As shown in FIGS. 3 and 4, the first turnover piece 1 and the second turnover piece 2 have U-shaped cross-section.

The first turnover piece 1 and the second turnover piece 2 have the same shape but different lateral dimensions. The lateral dimension of the second turnover piece 2 is larger than that of the first turnover piece 1, ensuring that one end of the first turnover piece 1 can be inserted into the second turnover piece 2.

As shown in FIG. 1, the right end of the first turnover piece 1 is inserted into the left end of the second turnover piece 2 located on the right, and the first turnover piece 1 is hinged with the second turnover piece 2 by means of the shaft A5, enabling rotation of the second turnover piece 2 around the first turnover piece 1.

As shown in FIG. 1, when the first turnover piece 1 is in line with the second turnover piece 2, the lower edge of the right end of the first turnover piece 1 and the lower edge of the left end of the second turnover piece 2 on the right abut against each other. Thus, when pushing the first turnover piece 1 and the second turnover piece 2 along direction B, the first turnover piece 1 and the second turnover piece 2 cannot be turned over. In view of the above, the turnover device is steady when impacted by external force (direction B) at the bottom.

As shown in FIGS. 1 to 3, the first pull rod 3 is located in the first turnover piece 1.

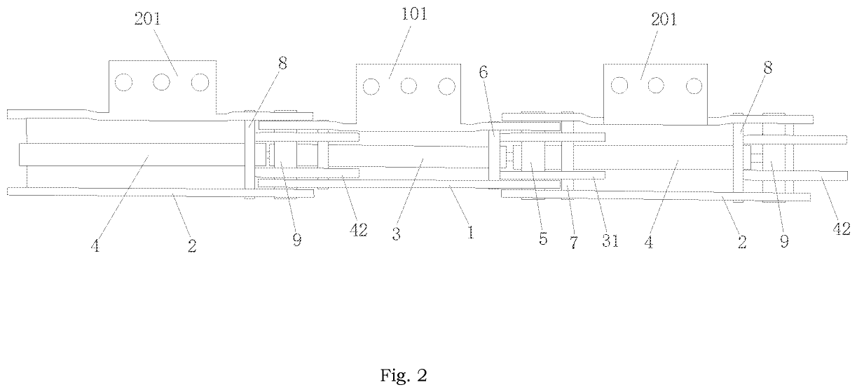

As shown in FIG. 5, the right end of the first pull rod 3 is provided with a first hinge 31 which located at the joint position between the first turnover piece 1 and the second turnover piece 2 (shown in FIG. 2) and the first hinge 31 is rotatably connected with the first pull rod 3, thus, the first hinge 31 can be turned over relative to the first pull rod 3.

As shown in FIGS. 1 and 3, the shaft A5 is inserted into the first hinge 31, and the first hinge 31 is rotatable around the shaft A5.

As shown in FIG. 3, two ends of the shaft B7 are fixed on two side walls of the second turnover piece 2 respectively, and the shaft B7 is inserted into the first hinge 31 which is rotatable around the shaft B7.

As shown in FIG. 5, the rotation hole 311 within which the first hinge 31 is rotatable around the shaft A5 has a obround shape. When the second turnover piece 2 rotates around the shaft A5, the second turnover piece 2 drives the shaft B7 to rotate synchronously. The obround shaped rotation hole 311 can ensure that the first hinge 31 can also rotate around the shaft A5 as the shaft B7 rotates. When the first hinge 31 rotates, the first hinge 31 will move the first pull rod 3 laterally.

As shown in FIGS. 1 to 3, the second pull rod 4 is located in the second turnover piece 2, and the structure of the second pull rod 4 is the same as that of the first pull rod 3.

As shown in FIG. 5, in this embodiment, the first hinge 3 is composed of two hinged pieces arranged in parallel, which are located on both sides of the first pull rod 3respectively, so that when the first hinge 3 rotates, the first pull rod can move left and right evenly. In other embodiments, the first hinge 3 may also be composed of a single hinge piece.

As shown in FIG. 1, when the first turnover piece 1 is in line with the second turnover piece 2, the right end of the first pull rod 3 and the left end of the second pull rod 4 abut against each other.

As shown in FIG. 5, the right end of the first pull rod 3 is formed with a first protrusion 32, and the left end of the first pull rod 3 is formed with a second recess 33. As shown in FIG. 1, when the first turnover piece 1 is in line with the second turnover piece 2, the right end of the first pull rod 3 abuts against the left end of the second pull rod 4 on the right and the first protrusion 32 on the first pull rod 3 is insert into the first recess on the second pull rod 4, ensuring that the first pull rod 3 and the second pull rod 4 abut firmly. The right end of the second pull rod 4 is formed with a second protrusion 43 which has the same shape and size as the first protrusion 32. Additionally, the first recess 41 and the second recess 33 have the same shape and size.

As shown in FIGS. 1 and 3, two ends of the first limit shaft 6 are fixed on two side walls of the first turnover piece 1 respectively, the first pull rod 3 is located below the first limit shaft 6, and the upper end surface of the first pull rod 3 is in contact with the first limit shaft 6. As shown in FIG. 1, the first limit shaft 6 can prevent the first pull rod 3 from tilting during the movement in the left and right direction, which ensures the stability of the first turnover piece 1 and the second turnover piece 2 when they are in line or during turnover process.

As shown in FIG. 1, the right end of the second pull rod 4 is provided with a second hinge 42 which is located at the joint position between the second turnover piece 2 and the next first turnover piece 1 on the right, and the second hinge 42 is rotatably connected with the second pull rod 4, thus, the second hinge 42 can be turned over relative to the second pull rod 4.

As shown in FIG. 1, two ends of the shaft C9 are fixed on the two side walls of the second turnover piece 2 respectively. When the right side of the second turnover piece 2 located on the right is provided with another first turnover piece 1, the another first turnover piece 1 is hinged with the second turnover piece 2 by the shaft C9. The shaft C9 is inserted into the second hinge 42, thus the second hinge 42 can rotate around the shaft C9 within a obround shaped rotation hole, so that when the first turnover piece 1 on the right side of the second turnover piece 2 rotates around the shaft C9, the second hinge 42 also rotates around the shaft C9, which will move the second pull rod 4 on the right laterally.

The second hinge 42 and the first hinge 31 have the same structure.

As shown in FIG. 3, two ends of the second limit shaft 8 are fixed on the two side walls of the second turnover piece 2 respectively, the second pull rod 4 is located below the second limit shaft 8, and the upper end surface of the second pull rod 4 is contact with the second limit shaft 8. As shown in FIG. 1, the second limit shaft 8 can prevent the second pull rod 4 from tilting during the left and right movement, ensuring that stability of the first turnover piece 1 and the second turnover piece 2 when they are in line or during turnover process. Besides, the upper left of the second pull rod 4 on the right being limited by the shaft B7 and the upper right being limited by the second limit shaft 8 prevents the left and right ends of the second pull rod 4 from tilting during the movement.

As shown in FIG. 3, a lateral first connecting plate 101 is integrally formed on a side wall of the first turnover piece 1, and a lateral second connecting plate 201 is integrally formed on aside wall of the second turnover piece 2. When the turnover device is installed on two sides of the rolling shutter door, the door pieces of the door body can be fixed on the first connecting plates 101 (such as by screws, rivets, etc.), and the door pieces of the door body can be fixed on the second connecting plates 201 (such as by screws, rivets, etc.), thus, the installation of the door pieces to the turnover device is very convenient and fast.

As shown in FIG. 1, in this embodiment, the number of the first turnover piece 1 is one, and the number of the second turnover pieces 2 is two. The first one of the second turnover pieces 2, the first turnover piece 1, and the second one of the second turnover pieces 2 are sequentially connected from left to right.

As shown in FIG. 1, the right end of the second turnover piece 2 on the left is hinged to the left end of the first turnover piece 1 by means of the shaft C9, and the right end of the first turnover piece 1 is hinged to the left end of the second turnover piece 2 on the right by means of the shaft A5. The left end of the first turnover piece 1 is inserted into the second turnover piece 2 on the left, and the right end of the first turnover piece 1 is inserted into the second turnover piece 2 on the right.

As shown in FIG. 1, when the second turnover piece 2 on the left, the first turnover piece 1 and the second turnover piece 2 on the right are in line, the right end of the second pull rod 4 in the second turnover piece 2 on the left and the left end of the first pull rod 3 in the first turnover piece 1 abut against each other, and the right end of the first pull rod 3 and the left end of the second pull rod 4 in the second turnover piece 2 on the right abut against each other. Meanwhile, the second protrusion 43 of the right end of the second pull rod 4 on the left is inserted into the second recess 33 at the left end of the first pull rod 3, and the first protrusion 32 at the right end of the first pull rod 3 is inserted into the first recess 41 at the left end of the second turnover piece 2 on the right. The second hinge 42 at the right end of the second pull rod 4 on the left can rotate around the shaft C9. As the second hinge 42 is installed in the first turnover piece 1 by means of shaft D14, the second hinge 42 can also rotate around the shaft D14. Additionally, a second limit shaft 8 is provided at the upper right of the second pull rod 4 on the left. The left part of the first pull rod 3 in the first turnover piece 1 is located below the shaft D14 and the right part is located below the first limit shaft 6. The first hinge 31 at the right end of the first pull rod 3 can rotate around the shaft A5, and can also rotate around the shaft B7 as the first hinge 31 is installed in the second turnover piece 2 on the right by means of the shaft B7, the first hinge 31. The second hinge 42 at the right end of the second pull rod 4 on the right can rotate around the shaft C9, and the second hinge 42 can be installed in the first turnover piece 1 connected on the right (not shown). A second limit shaft 8 is provided at the upper right of the pull rod 4 on the right. The left part of the second pull rod 4 on the right is located below the shaft B7 and the right part is located below the second limit shaft 8.

As shown in FIG. 1, in this embodiment, the number of the first turnover piece 1 is one, the number of the second turnover piece 2 is two, the first one of the second turnover pieces 2, the first turnover piece 1, and the second one of the second turnover pieces 2 are connected sequentially from left to right. In other embodiments, according to the requirements of use, the number of the first turnover pieces 1 can be selected as other values from 1 to N (N is a natural number greater than or equal to 1), and the number of the second turnover pieces 2 can be selected as other values from 1 to M (M is a natural number greater than or equal to 2), wherein a plurality of first turnover pieces 1 and a plurality of second turnover pieces 2 are hinged connected alternately, and the connection modes between the first turnover pieces 1 and the second turnover pieces 2 are the same, therefore the length of the turnover device can be extended indefinitely as required.

As shown in FIG. 1, when the first turnover piece 1 is in line with the two second turnover pieces 2, as the edge of the lower left end of the first turnover piece 1 and the edge of the lower right end of the second turnover piece 2 on the left abut against each other, and the edge of the lower right end of the first turnover piece 1 and the edge of the lower left end of the second turnover piece 2 on the right abut against each other, when the bottom of the first turnover piece 1, the bottom of the second turnover piece 2 or the joint position of the bottoms of the first turnover piece 1 and the second turnover pieces 2 is vertically pushed in a direction B, the first turnover piece 1 and the second turnover pieces 2 cannot be turned over, that is, the turnover device is immobilized when its bottom suffers from external impact.

Meanwhile, when the first turnover piece 1 is in line with the two second turnover pieces 2, the first turnover piece 1 and the second turnover pieces 2 cannot be turned over when the top of the first turnover piece 1, the top of the second turnover pieces 2, or the top joint position of the first turnover piece 1 and the second turnover pieces 2 in the direction of A, since second pull rod 4 on the left, the first pull rod 3 and the second pull rod 4 on the right abut against each other, that is, the top of the turnover device is also immobilized when it suffers from external impact. Besides, the second pull rod 4 on the left and the first pull rod 3 abut against each other by means of the insert cooperation of the second protrusion 43 and the second recess 33, and the first pull rod 3 and the second pull rod 4 on the right abut against each other by means of the insert cooperation of the first protrusion 32 and the first recess 41, which further improves the stability of the top when the first turnover piece 1 is in line with the second turnover pieces 2 in case of the top of it subjecting to impact force.

As shown in FIG. 1, when the first turnover piece 1 is in line with the two second turnover pieces 2, the turnover device is immobilized whether subjected the impact force from the bottom or the pulling force from the bottom (or the pushing force from the top), thus, the device can be widely used, such as used on two sides of rolling shutter doors, used in building working platforms, bridges, lap beams in case of breaking roads, and top beams of temporary houses, etc.

As shown in FIG. 1, when it needs to be turned over and collected, the second turnover piece 2 on the right must firstly be turned, otherwise the first turnover piece 1 in the middle and the second turnover piece 2 on the left cannot turn over. When the second hinge 42 on the right is rotated in the direction of C (when a further first turnover piece 1 is installed on the right side of the second turnover 2 on the right, the rotation of the second hinge 42 on the right can also be achieved by turning the first turnover piece 1), the second pull rod 4 on the right is driven to move in the direction of D, rendering the left end of the second pull rod 4 on the right separated from the first pull rod 3. The second turnover piece 2 on the right can be turned in the direction of E, and when the second turnover piece 2 on the right is turned in the direction of E, the first hinge 31 is also rotated via the shaft B7, which drives the first pull rod 3 to move in the direction of F, resulting in the left end of the first pull rod 3 separated from the second pull rod 4 on the left. The first turnover piece 1 can be turned in the direction of G, and when the first turnover piece 1 is turned in the direction of G, the second hinge 42 on the left can be rotated via the shaft D14, which drives the second pull rod 4 on the left to move in the direction of H. When a further first turnover piece 1, a further first pull rod 3, and a further first hinge 31 are installed on the left side of the second turnover piece 2 on the left, the second turnover piece 2 on the left can also be rotated in the direction of I. Similarly, when multiple first turnover pieces 1 and multiple second turnover pieces 2 are connected alternately, the second turnover piece 2, the first turnover piece 1, the second turnover piece 2, the first turnover piece 1, the second turnover piece 2 . . . can be turned over from right to left one by one, eventually realizing the turnover and collecting of the entire device.

The turnover device of the present invention can be used on a rolling shutter door, wherein two sets of turnover devices are installed on two sides of the door body, and the door body is immobilized whether suffers from external impact or pulling force, thus, the turnover devices on two sides of the rolling shutter door can replace the existing door slot provided on the wall to fix the door body, which not only can reduce the installation costs of the rolling shutter door (that is, no need to provide door slots on the wall), but also can improve the overall aesthetics of the rolling shutter door.

The turnover device of the present invention can also be used on a conveyor belt, as long as transfer plates parallel arranged are installed between the two sets of turnover devices.

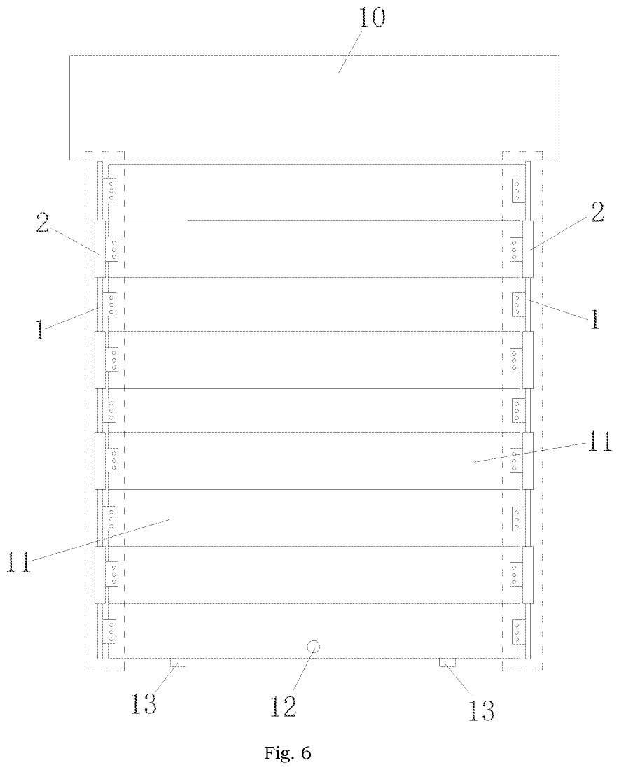

FIG. 6 schematically shows the structure of a slotless rolling shutter door according to an embodiment of the present invention.

As shown in FIG. 6, the slotless rolling shutter door comprises two sets of the aforementioned turnover device, door body and door body winding device 10.

As shown in FIG. 6, the door body comprises a plurality of door pieces 11, which are located between the two sets of turnover devices.

From top to bottom, the left end of the first door piece 11 is fixed on the first connecting plate 101 of the left first turnover piece 1 by rivets (or screws), and the right end of the first door piece 11 is fixed on the first connecting plate 101 of the first turnover piece 1 on the right by rivets (or screws).The left end of the second door piece 11 is fixed on the second connecting plate 201 of the second turnover piece 2 on the left by rivets (or screws), and the right end of the second door piece 11 is fixed on the second connecting plate 201 of the second turnover piece 2 on the right by rivets (or screws). The left end of the third door piece 11 is fixed on the first connecting plate 101 of the first turnover piece 1 on the left by rivets (or screws), and the right end of the third door piece 11 is fixed on the first connecting plate 101 of the first turnover piece 1 on the right by rivets (or screws). To sum up, the left and right ends of the plurality of door pieces 11 are connected with the two sets of turnover devices according to the above process, in which two adjacent door pieces 11 are arranged in parallel.

As shown in FIG. 6, the door body winding device 10 is installed on the top of the door body.

In this embodiment, the door body winding device 10 is an electric. In other embodiments, the door body winding device 10 can also be manual.

As shown in FIG. 6, a lock body 12 is installed at the bottom of the door body (on the lowest door piece 11), thus, when the door body is in closed state, the lock body 12 can ensure that the door body will not be rolled up by other person, thereby achieving the purpose of anti-theft.

As shown in FIG. 6, the bottom end of the door body (on the lowest door piece 11) can also be equipped with two pins 13, when the door body is closed, the pins 13 at the bottom of the door body can be inserted into the holes provided on the ground to further improve the impact resistance of the door body. In other embodiments, the number of the pins 13 may be changed according to the width of the door body, or the pins 13 may not be provided. In other embodiments, the pin 13 can also be designed as a circular arc shape and hinged with the door body (the lowest door piece 11). When the bottom end of the door body contacts the ground, the ground pushes one end of the pin 13 to make the pin 13 rotate, meanwhile, the other end of the pin 13 can be inserted into the hole provided on the wall to improve the impact resistance of the door body.

As shown in FIG. 6, the door body of the slotless rolling shutter door is immobilized whether suffers from external impact or pulling force, thus, the turnover devices on two sides of the rolling shutter door can replace the existing door slot provided on the wall to fix the door body, which not only can reduce the installation costs of the rolling shutter door (that is, no need to provide door slots on the wall), but also can improve the overall aesthetics of the rolling shutter door. When the door body needs to be opened, the door body winding device 10 can windup the turnover device with the door piece 11 from top to bottom, and finally collect the door body and the turnover device into the door body winding device 10. Meanwhile, when the door body is very wide as required, multiple slotless rolling shutter doors can be connected togetherside by side to prevent the door from shaking resulting from the excessive width of the door body. In addition, when the door piece is made of bullet-proof steel plate, bulletproof and explosion-proof function can be realized, and thus security is greatly guaranteed. Moreover, when the door body is placed laterally, the door pieces 11 can be rolled up and down, and when the door body is placed longitudinally, the door pieces 11 can be rolled left and right.

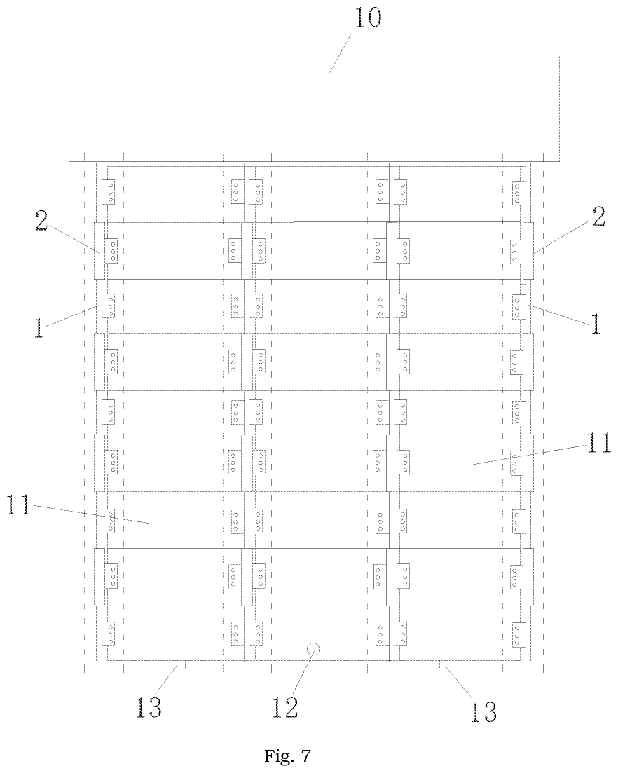

FIG. 7 schematically shows the structure of a slotless rolling shutter door according to another embodiment of the present invention.

As shown in FIG. 7, when the dimension in left and right direction of the door body need to be very wide, four sets of turnover devices and three sets of door bodies can be arranged alternately, so as to further prevent from shaking caused by the excessive width of the door body, and thus the safety is further improved. As the two sets of turnover devices in the middle, the first connecting plate 101 can be arranged on both sides of the first turnover piece 1, and the second connecting plate 201 can be arranged on both sides of the second turnover piece 2, so that door pieces 11 can be installed both on the left and right sides of the two sets of turnover devices in the middle, wherein the installation method of the door pieces 11 is the same as in FIG. 6.

As shown in FIG. 7, the door body winding device 10 is installed on the top of the door body.

In this embodiment, the door body winding device 10 is electric. In other embodiments, the door body winding device 10 can also be manual.

As shown in FIG. 7, a lock body 12 is installed at the bottom of the door (on the lowest door piece 11), thus, when the door body is in closed state, the lock body 12 can ensure that the door body will not be rolled up by other person, achieving the purpose of anti-theft.

As shown in FIG. 7, the bottom end of the door body (on the lowest door piece 11) can also be equipped with two pins 13, thus, when the door body is closed, the pins 13 at the bottom end of the door body can be inserted into the holes provided on the ground to further improve the impact resistance of the door body. In other embodiments, the number of the pins 13 may be changed according to the width of the door body, or the pins 13 may be omitted. In other embodiments, the pin 13 can also be designed as a circular arc shape and hinged with the door body (the lowest door piece 11), thus when the bottom end of the door body contacts the ground, the ground pushes one end of the pin 13 to make the pin 13 rotate, meanwhile, the other end of the pin 13 can be inserted into the hole provided on the wall to improve the impact resistance of the door body.

As shown in FIG. 7, the door body of the slotless rolling shutter door is immobilized whether suffers from external impact or pulling force, thus, the turnover devices on two sides of the rolling shutter door can replace the existing door slot provided on the wall to fix the door body, which not only can reduce the installation costs of the rolling shutter door (that is, no need to provide door slots on the wall), but also can improve the overall aesthetics of the rolling shutter door. When the door body needs to be opened, the door body winding device 10 can windup the turnover device with the door piece 11 from top to bottom, and finally collect the door body and the turnover device into the door body winding device 10. In addition, when the door piece is made of bullet-proof steel plate, bulletproof and explosion-proof function can be realized, and thus, security is greatly guaranteed. When the door body is placed laterally, the door pieces 11 can be rolled up and down, and when the door body is placed longitudinally, the door pieces 11 can be rolled left and right.

What have been described above are only some embodiments of the present invention. For those of ordinary skill in the art, modifications and improvements can be made without departing from the inventive concept of the present invention, which will all fall within the protection scope of the present invention.

1. A turnover device, comprising a first turnover piece, a second turnover piece, a first pull rod and a second pull rod,
wherein both the first turnover piece and the second turnover piece have U-shaped cross-section,
one end of the first turnover piece is inserted into one end of the second turnover piece,
the first turnover piece is hinged with the second turnover piece by means of a shaft A, and
when the first turnover piece is in line with the second turnover piece, the lower edge of one end of the first turnover piece and the lower edge of one end of the second turnover piece abut against each other,
wherein the first pull rod is located in the first turnover piece,
one end of the first pull rod is provided with a first hinge being rotatable around the shaft A within a obround rotation hole,
the first hinge is rotatably connected with the first pull rod,
the second pull rod is located in the second turnover piece, and
when the first turnover piece is in line with the second turnover piece, one end of the first pull rod and one end of the second pull rod abut against each other.

2. The turnover device according to claim 1, wherein one end of the first pull rod is provided with a first protrusion and the second pull rod is provided with a first recess which cooperates with the first protrusion.

3. The turnover device according to claim 1, further comprising a first limit shaft, both ends of which are provided on two side walls of the first turnover piece respectively,
wherein the first pull rod is located below the first limit shaft, and the upper end surface of the first pull rod is in contact with the first limit shaft.

4. The turnover device according to claim 1, further comprising a shaft B, two ends of which are provided on two side walls of the second turnover piece respectively, the shaft B being inserted in the first hinge, and the first hinge being rotatable around the shaft B.

5. The turnover device according to claim 1, further comprising a second limiting shaft and a shaft,
wherein both ends of the shaft are provided on the two side walls of the other end of the second turnover piece respectively,
the other end of the second pull rod is provided with a second hinge which is rotatably connected with the second pull rod,
the second hinge is rotatable around the shaft,
two ends of the second limit shaft are provided on the two side walls of the second turnover piece respectively,
the second pull rod is located below the second limit shaft, and
the upper end surface of the second pull rod is in contact with the second limit shaft.

6. The turnover device according to claim 1, wherein the other end of the first pull rod is provided with a second recess, and
the other end of the second pull rod is provided with a second protrusion.

7. The turnover device according to claim 1, wherein a side wall of the first turnover piece is provided with a lateral first connecting plate, and
a side wall of the second turnover piece is provided with a lateral second connecting plate.

8. The turnover device according to claim 5, wherein the number of the first turnover pieces is N and the number of the second turnover pieces is M, N being a natural number greater than or equal to 1 and M being a natural number greater than or equal to 2,
wherein the first turnover pieces and the second turnover pieces are connected alternately,
one end of the first turnover piece is hinged with one end of the second turnover piece by means of the shaft A, the other end of the first turnover piece is hinged with one end of another second turnover piece by means of the shaft C, and
one end of the first turnover piece is inserted into one end of the second turnover piece, the other end of the first turnover piece is inserted into one end of the another second turnover piece.

9. A slotless rolling shutter door, comprising at least two sets of the turnover devices according to claim 1, a door body and a door body winding device,
Wherein the door body comprises at least two door pieces which are located between two sets of turnover devices,
Wherein one end of the first door piece is provided on a side wall of a first turnover piece, and the other end is provided on a side wall of another first turnover piece,
one end of the second door piece is provided on a side wall of a second turnover piece, and the other end is provided on a side wall of another second turnover piece,
two adjacent door pieces are arranged in parallel, and
the door body winding device is provided on the top of the door body.

10. The slotless rolling shutter door according to claim 9, wherein a lock body is provided at the bottom of the door body.

11. The turnover device according to claim 2, wherein the other end of the first pull rod is provided with a second recess, and
the other end of the second pull rod is provided with a second protrusion.

12. The turnover device according to claim 3, wherein the other end of the first pull rod is provided with a second recess, and
the other end of the second pull rod is provided with a second protrusion.

13. The turnover device according to claim 4, wherein the other end of the first pull rod is provided with a second recess, and
the other end of the second pull rod is provided with a second protrusion.

14. The turnover device according to claim 5, wherein the other end of the first pull rod is provided with a second recess, and
the other end of the second pull rod is provided with a second protrusion.

15. The turnover device according to claim 2, wherein a side wall of the first turnover piece is provided with a lateral first connecting plate, and
a side wall of the second turnover piece is provided with a lateral second connecting plate.

16. The turnover device according to claim 3, wherein a side wall of the first turnover piece is provided with a lateral first connecting plate, and
a side wall of the second turnover piece is provided with a lateral second connecting plate.

17. The turnover device according to claim 4, wherein a side wall of the first turnover piece is provided with a lateral first connecting plate, and
a side wall of the second turnover piece is provided with a lateral second connecting plate.

18. The turnover device according to claim 5, wherein a side wall of the first turnover piece is provided with a lateral first connecting plate, and
a side wall of the second turnover piece is provided with a lateral second connecting plate.

19. A slotless rolling shutter door, comprising at least two sets of the turnover devices according to claim 2, a door body and a door body winding device,
Wherein the door body comprises at least two door pieces which are located between two sets of turnover devices,
Wherein one end of the first door piece is provided on a side wall of a first turnover piece, and the other end is provided on a side wall of another first turnover piece,
one end of the second door piece is provided on a side wall of a second turnover piece, and the other end is provided on a side wall of another second turnover piece,
two adjacent door pieces are arranged in parallel, and
the door body winding device is provided on the top of the door body.

20. The slotless rolling shutter door according to claim 19, wherein a lock body is provided at the bottom of the door body.
